(19) United States
(12) Patent Application Publication
(10) Pub. No.: US 2005/0153077 A1
(43) Pub. Date: Jul. 14, 2005

(54) Method of resisting contaminant build up and oxidation of vehicle surfaces and other surfaces

(75) Inventors: Anthony A. Gedeon, St. Augustine, FL (US); Arthur B. Gedeon, St. Augustine, FL (US); N. Andrew Greig, Arlington, VA (US)

Correspondence Address: Charles J. Prescott, P.A.;Suite 115, 2033 Wood Street, Sarasota, FL, 34237, US

(73) Assignee: Anthony Gedeon

(21) Appl. No.: 11/004,362

(22) Filed: Dec. 3, 2004

Related U.S. Application Data
(60) Provisional application No. 60/526,531, filed on Dec. 3, 2003.

(51) Int. Cl. B05D 3/02; B32B 9/04

(52) U.S. Cl. 427/384; 428/447

(57) ABSTRACT

Coating compositions and methods for applying reactive silanol coating compositions having electron deficient surfaces when cured wherein organic radical groups from the silanes are forced to the surface of the coating. The interpenetrating silicon-oxygen structure below the surface skews the electron cloud downward creating a net positively charged surface which is hydrophobic and oleophobic to repel contaminants by discouraging light hydrogen bonding. The surface is also extremely tight and thereby absent nutrients for microorganisms, discourages organic growth. These unique qualities provide cleanliness solutions for automotive and marine applications, including substrates subjected to elevated temperatures typically destructive to organic coatings (paints). Substrate examples are: brakes to repel brake dust on wheels; coating of engines and engine accessories, high-temperature exhausts/stacks/eductors, and engine compartments; automotive, architectural, industrial, and marine exterior substrates; and preservation and restoration of vehicles and boat interiors, seats, and instrument panels/dashboards and the like.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

This invention relates generally to the protection of surfaces from contaminants and debris build up and from oxidation and more particularly to an improved method of using oligomeric siloxane coatings, applied as reactive silanol sols, as a contaminant-resistant surface protectant and for creating an easy-clean surface, and for the production of articles exhibiting contamination resistant, easy-clean properties.

2. Description of Related Art

Siloxane coatings applied as reactive silanol sols have been granted three US patents known to applicants: Schutt & Gedeon, U.S. Pat. No. 5,929,159, Oligomeric silicon coating compositions, articles coated therewith and method for forming coating composition and coated articles based thereon; Schutt, U.S. Pat. No. 6,432,191, Silane-based, coating compositions, coated articles obtained there from and methods of using same; and Schutt/Gedeon/Stanich, U.S. Pat. No. 6,451,382, Method for improving heat efficiency using silane coatings and coated articles produced thereby the entire disclosures of which are incorporated herein, in their entireties, by reference thereto.

The content of matter formulas described in these patents and any current or future derivative formulas for reactive silanols where such materials are applied using the methods defined herein for the purposes claimed herein are incorporated by reference. While not wishing to be bound by the following formulae provided for information, examples of reactive silanol compositions as described in the referenced Schutt et. al. patents are any coating, polish, primer, penetrant, sealer, or surface modification treatment comprised of an aqueous or non-aqueous oligomeric low molecular weight silanol formed by admixing
(a) at least one silane of the formula (1)
   R¹ₙSi(OR²)_{4-M} (1)
   where R¹ represents a C₁-C₆ alkyl group, a C₆ C₈ aryl group or a functional group including at least one of vinyl, acrylic, amino, mercapto, or vinyl chloride functional groups, R₂ represents a C₁-C₆ alkyl or acetyl group and n is a number of 1 or 2;
(b) silane condensation catalyst, and
(c) C₂-C₄ alkanol solvent, and;
(d) (ii) colloidal aluminum hydroxide, (iii) metal alcoholate of formula (2):
   M(OR³)ₘ (2)
   where M is a metal valence 2, 3 or 4, or mixture of two or more such metals;
      R³ represents a C₁-C₆ alkyl group,
      m represents a number or 2, 3 or 4, or mixture of (ii) and (iii); and
(e) water.

Alternately, an aqueous or non-aqueous oligomeric silanol composition formed by admixing:
(a) at least one silane of the formula (1)
   R¹ₘSi(OR²)₄₋ₙ (1)
   where R¹ represents a lower alkyl group, a C₆-C₈ aryl group or a functional group including at least one of vinyl, acrylic, amino, mercapto, or vinyl chloride functional groups;
(b) silane condensation catalyst,
(c) lower alkanol solvent
(d) colloidal aluminum hydroxide or metal alcoholate of formula (2):
   M(OR³)ₘ (2)
   where M is a metal valence 2, 3 or 4, or mixture of two or more such metals;
   R represents a lower alkyl group; and,
   m represents a number or 2, 3 or 4;
(e) silica component selected from the group consisting of alkali metal silicate, ethyl orthosilicate, ethyl polysilicate, and colloidal silica dispersed in lower alkanol;
(f) color forming silanol condensation catalyst;
(g) epoxysilane;
(h) ultrafine titanium dioxide ultraviolet light absorber;
(i) water;
(j) co-solvent;
   or any reactive silanol pre-catalyzed (hydrolyzed) by adding water and additives to silanes and inducted for at least five, but not more than 20 minutes, and then diluted with solvent such as, but not limited to, lower alkanols such as isopropyl and ethyl alcohol to inhibit further polycondensation and cross-linking so as to be subsequently applied as 1-part reactive silanol that can be applied to a surface by spraying, brushing, or wiping; and which then optionally can be cross-linked into a polysolixane film by applying water and, preferably, water acidified with acetic acid or a mineral acid such as boric acid or other condensation additive where that water or aqueous mixture is mechanically buffed into the silanol layer using a wiping cloth, preferably, a microfiber polishing cloth or mechanical buffing wheel or similar device.

Silane technology dates back to the 1930's. Silicon-based or silicon-containing coatings and penetrants that can be applied and cured at ambient temperatures include silanes (typically alkylalkoxysilanes or alkyltrialkoxysilanes), siloxanes (typically oligomerous alkylalkoxysiloxanes or silsesquioxanes), silicates (including ethyl silicates, sodium silicates, and potassium silicates), methyl siliconates, blends of the above, and hybrid organic-inorganic paints and coatings including silicone alkyds, epoxy-siloxane coatings and acylic-siloxane coatings. In a recent symposium, a good history of recent developments was given by N. Andrew Greig of Arlington, Va.; “A Brief Overview of Reactive Silanes and other Siloxane Coatings as Corrosion Preventatives”.

In the early 1970s, Harold A. Clark of Dow Corning Corporation patented a variety of siloxane systems for lens coatings, fire-retardant binders for fire insulation, and a new variety of paints (see U.S. Pat. Nos. 3,944,762, 3,976,497, and related patents). Clark's invention involved generating RSi(OH)₃ silanols in situ by adding trialkoxysilanes in an isopropyl alcohol-water carrier to an acidic dispersion of colloidal silica (Arkles, 607). This resulting sol condenses into a siloxanol polymer gel forming Si—O—Si chains that further cures to form a hard, adherent layer of silsesquioxanes (RsiO_{2/3}). Clark created paint coatings by adding a variety of pigments to form flame-resistant paints and high-gloss enamels, to name a few.

When the Clark patents from 1976 expired, Dr. John Schutt of NASA Goddard and Tony Gedeon developed a new siloxane approach to overcome a weakness in the original Dow patents. Specifically, their U.S. Pat. No. 5,929,159 in July 1999 claimed that use of colloidal silica, “especially when used in or near the amounts contemplated by the above Dow Corning (Clark) patents, renders the coatings porous or microporous and drastically reduces the corrosion resistance of the coatings.” Their approach was to replace colloidal silica with divalent cations, particularly, Ca⁺².

Again quoting from the '159 patent:

“Generally, when the silicon atom is both trifunctionally and quadrifunctionally hydroxylated, the resulting siloxane network accommodates minimally the passage of water vapor and in some circumstances also the passage of water as well as oxygen. Because of this property, bonding resulting from the hydroxylation at a metallic interface is incomplete and corrosion can occur. The present coating compositions better utilize the reactivity of the silanol moiety with substrate oxy and hydroxy species and promote the formation of a contiguous interfacial layer unaffected by surface and bulk diffusion of water, water vapor and oxygen. This is accomplished, at least in part, by replacing all or most of the colloidal silica in formulations of the type described in the Dow Corning (Clark) patents mentioned above with divalent metal (M⁺²) ions, such as, for example, Cu⁺², Zn⁺², Ca⁺² Co⁺², and Mn⁺².
   Other objectives of the new coating cited in this '159 patent include:
to provide abrasion resistant coating compositions suitable for metallic and non-metallic surfaces.
to provide transparent, glass-like abrasion-resistant and corrosion resistant coating compositions as well as coated articles.
to provide such improved coating compositions as aqueous formulations with acceptable volatile organic component (VOC) levels and, therefore, environmentally acceptable.
to provide such coating compositions which may be prepared easily and economically and are easy to apply to various types of substrates.
to develop a coating composition suitable for coating marine surfaces, such as aluminum boat hulls, to render the surfaces corrosion resistant in a salt water environment.

The resultant condensed organic-inorganic hybrid layer is thin (5μ-1 mil), transparent, and hard (pencil hardness 11H). Because the molecular size of the silanols before they cure into siloxane oligomers is so small, the sol penetrates pores in the substrate to achieve better sealing and bonding. The substrate can be a metal, non-metal, or an organic coating.

Although not wishing to be bound by any particular theory of operation, the present invention recognizes the discovery that as oligomeric siloxane coatings polymerize from precursor reactive silanols as described in the referenced Schutt et. al. patents, the silicon atoms rotate to allow the larger organic groups upward mobility to the surface of the coating. While other silicon-based coatings described in the literature may exhibit surfaces with such polar properties, none exhibit the thermodynamically stable and dense structure developed from application of reactive silanols per the methods described herein. The structure so achieved is resistant to extremes of temperature, environmental stressors including ultraviolet radiation, rain, and pollutants, and cleaning chemicals; and is permanent unless removed by abrasion.

In the '491 patent, corrosion resistant coatings are provided by aqueous-alcoholic acidic dispersions of the partial condensate of monomethyl silanol (by hydrolysis of monomethyl alkoxysilane) alone or in admixture with minor amounts of other silanol, e.g., gamma-glycidyloxy silanol, phenyl silanol, etc., wherein the dispersions contain divalent metal cations, e.g. Ca⁺² in place of all or most of colloidal silica used in prior formations of this type.

The method of mixing (catalyzation) and application of reactive silanols of the types described in or derived from the prior art cited herein to achieve contaminant-resistant easy-clean surfaces involves the following steps:

1. Hydrolyzation of a specific alkoxysilane or a blend of alkoxysilanes with water to produce active silanol groups where R is a nonhydrolyzable organic substituent such as, but not limited to, a methyl (CH₃), ethyl (C₂H₅), propyl (C₂H₇), vinyl (C₂H₃), or phenyl (C₆H₅) group and where the hydrolyzable group is, but not limited to at least one and preferably three, methoxy (OCH₃), ethoxy (OC₂H₅), or chloro (Cl) group(s) as depicted in formula (3):
R—Si—(OCH₃)₊₃H₂O→R—Si—(OH)₃+3CH₂ OH↑ (3)

The water for hydrolyzation can be added as reagent-grade water, can come from the atmosphere, or be absorbed from the surface of the material being coated. Hydrolyzation releases an alcohol by-product, such as methanol or ethanol, which is released as a gas during open pot mixing. Open pot mixing is preferred to force formula (3) to the right (complete hydrolyzation) and to allow controlled release of alcohols, other solvents, or both.

2. Polycondensation to form predominantly linear oligomers of polysilanois (siloxanols) (formation of siloxane bonds) to form a reactive silanol sol per formula (4): 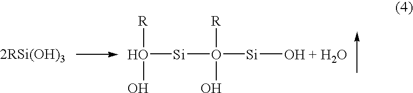
. . . and so on for 30-minute to 12-hour induction period.
   Reactive silanol sols as applied to methods described herein typically have isopropyl alcohol (IPA), ethyl alcohol, propylene glycol ethers, or other solvents added to reduce viscosity for surface penetration and wetting, and to accelerate evaporation of water. Curing agents such as, but not limited to, tetrabutoxytitanate and wetting agents may also be added to accelerate film formation and substrate bonding. Pigments, dyes, water soluble additives such as corrosion inhibitors, and chemically bonded additives such as corrosion inhibitors may be added to produce distinctive film properties, provided the additions are not so great to disrupt the development of a low-porosity interpenetrating network of organosolixanes with organic moieties oriented toward the surface.

3 to 5. Application and Curing:

The reactive silanol sol is applied to a surface and covalently bonds with surface oxides and hydroxides to form metal oxysilicates, condenses, and cross-links into amorphous interpenetrating network of siloxanes with organic moieties oriented toward the surface of the film per formulae (5).

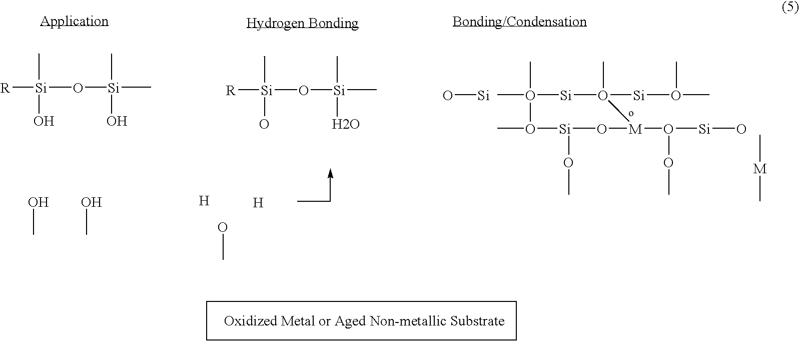

Note that water is both a reactant (hydrolyzation) and a reaction product (polycondensation and bonding with surface oxides and hydroxides). Acetic acid, boric acid, or other acids can be used to accelerate hydrolyzation and keep the structure open long enough to allow reaction product water and solvents to escape during substrate bonding.

Another method of producing polysiloxane films with reactive silanols involves partially catalyzing silanes with water and additives and inducting for at least five, but not more than 20 minutes, and then diluting with solvent such as, but not limited to, isopropyl alcohol to inhibit further polycondensation and cross-linking so as to be subsequently applied as 1-part reactive silanol that can be applied to a surface by spraying, brushing, or wiping; and which then optionally can be cross-linked into a polysolixane film by applying water and, preferably, water acidified with acetic acid or a mineral acid such as boric acid or other condensation additive that is mechanically buffed into the silanol layer using a wiping cloth, preferably, a microfiber polishing cloth or mechanical buffing wheel or similar device.

Although not wishing to be bound by any particular theory of operation, this invention notes that the structure of the cured film, namely a thin layer of interpenetrating polysiloxane with organic moieties predominately oriented toward the surface, accounts for the unique properties afforded to substrates treated with reactive silanols and that this structure depends not only on the Schutt et. al, content-of-matter patents cited as prior art, but on the mixing and application of the reactive silanol. Specifically:
Water up to 50% of the catalyzed silane-water-additives mixture, but preferably no more that 33% of the catalyzed mixture can be added in excess of the amount stoichiometrically needed for complete hydrolyzation of precursor alkoxysilanes to control the rate of polycondensation of oligomeric silanols and to improve wetting and application viscosity;
The post-catalyzation induction time can be adjusted to allow complete hydrolyzation of all precursor silanes and to allow formation of oligomers of polysilanols, but limited so that the mixture does not gel or form excessive molecular weight polymers (100,000 atomic mass units or greater) of reactive silanols that interfere with proper film formation;
Induction times and curing times can be modified by varying the amount and types of curing agents and acids used;
The blend of added solvents can be such that formation of cyclic silanols is inhibited and may be blended to achieve longer drying times to allow for overlapping coats (called wet line control);
Solvents can be added to the inducted mixture to reduce viscosity for application and increase pot life, but too much added solvent, including water, interferes with film formation and substrate bonding described herein to achieve contamination-resistant and easy-clean surfaces.

The thin, glass-like film is clear and, unlike clear organic coatings, does not yellow, oxidize, or lose gloss. Si—O bonds are not only 130% stronger than C—C bonds found in organic coatings, but the polysiloxane structure is almost fully oxidized making it thermodynamically stable. The organic substituents are largely excluded from cross-linking reactions so tend to rotate to the surface of the film as it cures. This property of reactive silanols not only accounts for the varying surface properties that can be engineered, but explains why reactive silanols should be applied only in very thin films. If the sol is allowed to pool into thick deposits, the organic groups cannot orient to the film-air interface causing incomplete cross-linking of the film.

### BRIEF SUMMARY OF THE INVENTION

Advances in siloxane coatings, particularly the invention of ambient temperature curing reactive silanol coatings, have arisen in the past several years that offer opportunities to solve problems that could not be addressed with traditional coating materials and methods. Although this class of coatings is cited for its corrosion resistance and robust environmental performance, they also exhibit the unusual phenomenon of having electron deficient surfaces. These are formed as the coating cures in that organic radical groups from the silanes employed are forced to the surface of the coating. The interpenetrating silicon-oxygen structure below skews the electron cloud downward creating a net positively charged surface. This produces a hydrophobic and oleophobic surface that repels contaminants by discouraging light hydrogen bonding. This unique quality provides cleanliness solutions for automotive and marine applications, including surfaces subjected to elevated temperatures typically destructive to organic coatings (paints). Particularly, this class of coatings significantly solves cleanliness and oxidation issues for lessening the impact of brake dust on wheels; for coating of engines, engine accessories, high-temperature exhausts/stacks/eductors, and engine compartments; truck beds and pick-up truck beds; automotive and marine exterior finishes and metals; and preservation and restoration of interiors, seats, floor mats and carpeting, steering wheels, and instrument panels/dashboards of cars, trucks, recreational vehicles, equipment and heavy equipment, and boats.

### REFERENTIAL EXAMPLES

The invention will now be illustrated by the following non-limiting methods and articles produced thereby. It is understood that these methods and preferred embodiments are given by way of illustration only and without intent to limit the invention thereto.

I. A method of rendering vehicle wheels resistant to brake dust accumulation and easily cleaned without harsh soaps or chemical by coating same as an overcoat to other coatings, or directly over metal or combinations of metal and other coatings, with oligomeric siloxanes, applied as catalyzed or partially catalyzed reactive silanol, to create a net positive surface charge on the coating to effect the stated properties.

II. A method of rendering vehicle and marine engine rooms, engine compartments and the contents thereof, stationary equipment, heavy equipment, hydraulic equipment, and other machinery, hydrophobic, oleophobic, and easily cleaned without harsh soaps or detergents by coating same with oligomeric siloxanes, applied as catalyzed or partially catalyzed reactive silanol, to create a net positive surface charge on the coating to effect the stated properties.

III. A method of restoring and/or preserving the appearance of interior components of vehicles, aircraft, boats, ships, or control centers of any type, including but not limited to seats, control or instrument panels, dashboards, side or “kick panels”, trim, steering wheels, metal, plastic or synthetic compound parts, control knobs, radios, shift or other levers, door handles, arm rests, carpet, rubber mats, and windows hydrophobic, oleophobic, and easily cleaned without harsh soaps or detergents by coating same with oligomeric siloxanes, applied as catalyzed or partially catalyzed reactive silanol, to create a net positive surface charge on the coating to effect the stated properties.

IV. A method of rendering the external finish of automobiles, boats, aircraft and ships, including but not limited to paint, metals, plastics, fiberglass, gel coat, chrome, rubber, synthetic compounds, and glass, hydrophobic, oleophobic, and easily cleaned without harsh soaps or detergents by coating same with oligomeric siloxanes, applied as catalyzed or partially catalyzed reactive silanol, to create a net positive surface charge on the coating to effect the stated properties.

V. A method of rendering truck beds, compartments, trunks, luggage compartments, lockers, storage compartments of vehicles, boats, aircraft, and ships hydrophobic, oleophobic, and easily cleaned without harsh soaps or detergents by coating same with oligomeric siloxane, applied as catalyzed or partially catalyzed reactive silanol, to create a net positive surface charge on the coating to effect the stated properties.

VI. A method of rendering surfaces of all types resistant to mold, easily cleaned of mold, hydrophobic, oleophobic, and easily cleaned without harsh soaps or detergents by coating same with oligomeric siloxanes, applied as catalyzed or partially catalyzed reactive silanol, to create a net positive surface charge on the coating to effect the stated properties.

VII. A method of providing a durable, hard, yet flexible surface coating for preservation of marine, automotive, aircraft trucks, equipment, heavy equipment, stationary equipment, hydraulic systems that provides long lasting clean-ability and resistance to contamination detergents by coating same with oligomeric siloxanes, applied as catalyzed or partially catalyzed reactive silanol, to create a net positive surface charge on the coating to effect the stated properties.

VIII. A method of providing a durable, hard and temperature-resistant and corrosion protecting coating for preservation of marine, aerospace, and industrial turbine generator parts, housings, cabling, blades, exhausts/eductors that provides soot and other contamination-resistance, abrasion resistant, and easy-clean surfaces by coating same with oligomeric siloxanes, applied as catalyzed or partially catalyzed reactive silanol, to create a net positive surface charge on the coating to effect the stated properties.

IX. A method of rendering marine and other safety devices and markings such as life-boats, life-preservers, label plates, safety signs, and safety equipment such as fire extinguishers painted or otherwise treated with special colors resistant to contamination or discoloration from ultraviolet radiation, salts, soot, guano, algae, mold, and pollutants and an easy-clean surface that promotes cleaning by rain water or mild detergent cleaning by coating same with oligomeric siloxanes, applied as catalyzed or partially catalyzed reactive silanol, to create a net positive surface charge on the coating to effect the stated properties.

X. A method of rendering exterior paints, powder coats, chromate conversion coats, and bare decorative or functional metal surfaces such as, but not limited to aluminum, brass, copper, and stainless steel resistant to contamination or discoloration from ultraviolet radiation, salts, chemicals, soot, guano, algae, mold, and pollutants and an easy-clean surface that promotes cleaning by rain water, tap water, or mild detergent cleaning by coating same with oligomeric siloxanes, applied as catalyzed or partially catalyzed reactive silanol, to create a net positive surface charge on the coating to effect the stated properties.

XI. A method rendering batteries, battery racks, vehicle battery pans, battery compartments, and other battery support structures and containers resistant to contamination or discoloration from ultraviolet radiation, salts, soot, guano, algae, mold, pollutants, and acid spills or acid rain and an easy-clean surface that promotes cleaning by rain water, tap water, or mild detergent cleaning by coating same with oligomeric siloxanes, applied as catalyzed or partially catalyzed reactive silanol, to create a net positive surface charge on the coating to effect the stated properties.

XII. A method of rendering architectural structures, facades, features, monuments, roadways, walks or other structures of concrete, masonry, granite, marble, natural stone, or man-made ceramic or glass materials and fabrics such as canvass, hemp, cotton, and man-made fabrics resistant to contamination or discoloration from ultraviolet radiation, salts, soot, guano, algae, mold, and pollutants and an easy-clean surface that promotes cleaning by rain water or mild detergent cleaning by coating same with oligomeric siloxanes, applied as catalyzed or partially catalyzed reactive silanol, to create a net positive surface charge on the coating to effect the stated properties.

XIII. A method of treating surfaces of solar panels, windshields, windows, and port holes to render these clear surfaces of glass, plastic, or other transparent material resistant to contamination from salts, soot, dirt, guano, mold, or algae and an easy-clean surface that promotes cleaning by rain water, tap water, or mild detergent cleaning by coating same with oligomeric siloxanes, applied as catalyzed or partially catalyzed reactive silanol, to create a net positive surface charge on the coating to effect the stated properties.

XIV. A method of rendering interior architectural features such as table tops, countertops, sink bases, or other features or devices of concrete, masonry, grout, granite, marble, coral, natural stone, or man-made ceramic or glass materials and natural or man-made fabrics resistant to contamination, staining, or discoloration from salts, soot, mold, food spills, cleaning chemical spills, and grease and an easy-clean surface that promotes cleaning by tap water or mild detergent cleaning by coating same with oligomeric siloxanes, applied as catalyzed or partially catalyzed reactive silanol, to create a net positive surface charge on the coating to effect the stated properties.

XV. A method of forming a thin coating of interpenetrating polysiloxane with organic moieties predominantly oriented toward the exposed surface of said coating to produce a permanent positive surface potential of said coating onto a substrate, said coating comprising a reactive silanol which is in the form of an aqueous or non-aqueous dispersion of the partial condensate of monomethyl or monethyl silanol formed by hydrolysis of monomethyl or monethyl alkoxysilane alone or in admixture with minor amounts of other silanols, wherein the dispersions contain divalent metal cations, alcohol or water dispersants additives such as, but not limited to, hydrolysis catalysts like acetic acid, ethylene glycol ether co-solvents, silicates or hydrolyzed silicates, solid or water-soluble pigments, gellation inhibitors like chromium acetate hydroxides, or metal alcholates of the of formula (2):
M(OR³)ₘ (2)
where M is a metal valence 2, 3 or 4, or mixture of two or more such metals;
R represents a lower alkyl group; and,
m represents a number or 2, 3 or 4;

XVI. A method of forming a thin coating of siloxane with organic moieties predominantly oriented toward the exposed surface of said coating to produce a positive surface potential of said coating onto a substrate, said coating comprising a pre-catalyzed reactive silanol, that is, an aqueous or non-aqueous dispersion of the partial condensate of monomethyl or monethyl silanol (by hydrolysis of monomethyl or monethyl alkoxysilane) alone or in admixture with minor amounts of other silanols, e.g., gamma-glycidyloxy silanol, phenyl silanol, etc, wherein the dispersions contain divalent metal cations, e.g., Ca⁺², in an alcohol dispersant, and which may optionally contain film-enhancing additives such as, but not limited to, hydrolysis catalysts, silicates or hydrolyzed silicates, solid or water-soluble pigments, gellation inhibitors like chromium acetate hydroxides, or metal alcholates of the of formula (2):
M(OR³)ₘ (2)
where M is a metal valence 2, 3 or 4, or mixture of two or more such metals;
R represents a lower alkyl group; and,
m represents a number or 2, 3 or 4;

XVII. A method of forming a thin, hard coating of polysiloxane with organic moieties predominantly oriented toward the exposed surface of said coating to produce a positive surface potential of said coating onto a substrate, said coating comprising a reactive silanol composition as set forth in referential example XVI, further comprising a hardener composed of water, acidified water preferably acidified with acetic acid, or water or acidified water and minor additions of additives such as epoxy or amino silanes applied by mechanical polishing to form and cure said siloxane at ambient temperatures whereby a hard, low porosity interpenetrating network of organosolixanes with organic moieties oriented toward the surface is formed on the substrate.

XVIII. A dense contaminant repellent siloxane coating composition formed onto a substrate wherein organic moieties of said coating are oriented toward the exposed surface thereof causing a permanent positively charged surface potential comprising a reactive silanol, that is, an aqueous or non-aqueous dispersion of the partial condensate of monomethyl or monethyl silanol (by hydrolysis of monomethyl or monethyl alkoxysilane) alone or in admixture with minor amounts of other silanols, e.g., gamma-glycidyloxy silanol, phenyl silanol, etc, wherein the dispersions contain divalent metal cations, e.g., Ca⁺², alcohol or water dispersants, and which may optionally contain film-enhancing additives such as, but not limited to, hydrolysis catalysts like acetic acid, ethylene glycol ether co-solvents, silicates or hydrolyzed silicates, solid or water-soluble pigments, gellation inhibitors like chromium acetate hydroxides, or metal alcholates of the of formula (2):
M(OR³)ₘ (2)
where M is a metal valence 2, 3 or 4, or mixture of two or more such metals;
R represents a lower alkyl group; and,
m represents a number or 2, 3 or 4;

XIX. A contaminant repellent siloxane coating composition formed onto a substrate wherein organic moieties of said coating are oriented toward the exposed surface thereof causing a positively charged surface potential comprising a pre-catalyzed reactive silanol, that is, an aqueous or non-aqueous dispersion of the partial condensate of monomethyl or monethyl silanol (by hydrolysis of monomethyl or monethyl alkoxysilane) alone or in admixture with minor amounts of other silanols, e.g., gamma-glycidyloxy silanol, phenyl silanol, etc, wherein the dispersions contain divalent metal cations, e.g., Ca⁺², in an alcohol dispersant, and which may optionally contain film-enhancing additives such as, but not limited to, hydrolysis catalysts, silicates or hydrolyzed silicates, solid or water-soluble pigments, gellation inhibitors like chromium acetate hydroxides, or metal alcholates of the of formula (2):
M(OR³)ₘ (2)
where M is a metal valence 2, 3 or 4, or mixture of two or more such metals;
R represents a lower alkyl group; and,
m represents a number or 2, 3 or 4;

XX. A contaminant repellent polysiloxane coating composition formed onto a substrate wherein organic moieties of said coating are oriented toward the exposed surface thereof causing a positively charged surface potential comprising a reactive silanol composition as set forth in referencial example XIX further comprising a hardener composed of water, acidified water preferably acidified with acetic acid, or water or acidified water and minor additions of additives such as epoxy or amino silanes applied by mechanical polishing to form and cure said siloxane at ambient temperatures whereby a hard, low porosity interpenetrating network of organosolixanes with organic moieties oriented toward the surface is formed on the substrate.

### DETAILED DESCRIPTION OF THE INVENTION

While not wishing to be bound by formulae provided for information, this invention is based on the discovery that reactive silanol compositions such as those described in the referenced Schutt et. al. patents, when catalyzed or partially catalyzed and applied to the methods described herein, cure into a dense, siloxane film where organic moieties are oriented toward the surface of the film causing a permanent, positive surface potential. The silicon atoms in the siloxane coating matrix strongly attract electrons, while the surface organic groups easily give up electrons. This provides an electron deficient surface that has a net positive charge for the life of the coating. The coating of automotive, aircraft, equipment, and marine components that are subject to contamination from oil, abrasive airborne products, and oxidation from heat are rendered resistant to such contamination and easy to clean with water or mild detergent as to cleaning with abrasives or harsh chemicals. These effects can be seen in multi-part and catalyzed and partially catalyzed one part siloxane coatings applied as reactive silanol sols. The coating of said automotive and marine components also allows for restoration of surfaces.

Siloxane coatings are very resistant to micro-organisms because of the very tight surface and the positive charged surface. Exhibit A is a report from a laboratory running the ASTM G-21 test for mold spores showing a perfect rating for lack of spores on a sample coated with a catalyzed siloxane coating using the method of the present invention compared to a control.

A simplified model of the cured protective coating applied to a surface in accordance with the present invention is shown below:

[image]

This simplified model of cured siloxane applied as a reactive silanol illustrating organic groups oriented at the surface of an interpenetrating network of siloxane covalently bonded to the substrate.

Siloxane coatings can be of two basic types. The first are the type of siloxane that is a multi-part catalyzed system as cited in the patents referenced or an organosilane catalyzed in a similar manner. The second is a partially catalyzed siloxane coating where moisture is absorbed from the air or artificial means to complete hydrolysis of component silanes upon application; or a partially catalyzed siloxane wherein sliane hydolyzation into silanols is interrupted by diluting with 50-90% by weight solvent. The partially hydrolyzed reactive silanol exhibits very low molecular weight silanols which can be applied to a surface by spray or wipe. After one to five minutes to allow the silanols to bond with the surface and to allow most of the solvent to solve off, catalyzing or curing agent such as dilute acetic acid in water is used to supply moisture for hydrolysis, polycondensation, and siloxane formation into a more robust film to form a very thin coating that is not as durable as a multi-part catalyzed coating, but can be easily applied by untrained consumers or maintenance personnel as a single or two-part system, usually in simple spray bottles.

### EXAMPLES

The invention will now be illustrated by the following non-limiting examples. It is understood that these examples are given by way of illustration only and without intent to limit the invention thereto.

### Example 1

### Wheels

A catalyzed siloxane coating is wiped or sprayed on the car, truck, motorcycle, recreational vehicle, or other wheel with an applicator pad, or spray bottle, or other spray device. The tire is usually also done. The coating is sprayed on with a spray bottle and excess is wiped off both tire and drips or runs are lightly tagged off with a soft towel. The resulting coated wheel is easily cleaned with water without soap. The protected surface displays a contaminant-resistant, hydrophobic, and easy-clean character.

### Example 2

### Wheels and Surface Finish of Automobiles

After cleaning the wheels and body and mild detergent and using an abrasive pad to remove brake dust and road grime from the alloy wheels, partially catalyzed 1-part reactive silanol is sprayed onto the wheels and car finish in areas approximately four square feet in area. After one to three minutes, the silanol is buffed into the surface with a dry cotton cloth. A mixture of 10 parts distilled water to one part white vinegar is applied to the treated surface with an atomizing hand spray bottle. The acidified water is mechanically buffed into the silanol until the water is removed and there are no streaks. These steps are repeated until the entire body, bumpers, light lenses, all wheels, and dashboard, door trim, and instrument panel are treated. The treated surfaces exhibited hydrophobicity, contamination resistance, and were easily cleaned by rainwater or by using tap water from a garden hose. This effect diminished over six months until the process was repeated. Unlike wax finishes, no stripping or dewaxing was required prior to surface cleaning with mild detergent, drying, and reapplying the 1-part partially catalyzed reactive silanol.

### Example 3

### Ford Motor

The Ford Motor Company conducted tests of siloxane coatings to slow the build up of brake dust and other contamination on wheels of cars with aggressive brake linings prone to significant brake dust. At Ford Six Sigma Center, wheels were coated on test vehicles and reflectivity of the surface of the wheel using the opposite side of the vehicle as a control was measured. The Table 1 below indicates that the higher numbers were the side that was coated. Note that most braking occurs on the front wheels, and rear wheels do not experience as significant a problem. The tests shown in Table 1 below show a 100% increase in reflectivity on the coated wheels, indicating a cleaner wheel.

TABLE 1
Refelectivity of Wheels Coated with Reactive Silanol
Black Navigator
VIN: 5LMFU27R13LJ00098
Mileage at which Reactive Silanol was
applied: 24125
Type of Wheels: 18″ 8-Spoke Al

| | Data Collection #1 | | | | Data Collection #2 | | | |
|---|---|---|---|---|---|---|---|---|
| | Mileage: 31000 | | | | Mileage: 31338 | | | |
| | Mileage Since Application: 6875 | | | | Mileage Since Data Collection #1: 338 | | | |
| | LF | LR | RF | RR | LF | LR | RF | RR |
| | Wheel | Wheel | Wheel | Wheel | Wheel | Wheel | Wheel | Wheel |
| Area 1 | 29.94 | 15.43 | 29.94 | 27.23 | 29.94 | 15.43 | 22.02 | 15.43 |
| Area 2 | 29.94 | 21.71 | 25.57 | 25.57 | 29.94 | 15.43 | 25.57 | 15.43 |
| Area 3 | 37.29 | 15.43 | 37.29 | 29.94 | 29.94 | 15.43 | 25.57 | 15.43 |
| Area 4 | 29.94 | 15.43 | 37.29 | 29.94 | 37.29 | 15.43 | 15.43 | 15.43 |
| Area 5 | 29.94 | 15.43 | 29.94 | 22.79 | 41.95 | 11.56 | 21.71 | 15.43 |
| Area 6 | 29.94 | 15.43 | 25.57 | 25.57 | 39.61 | 15.43 | 18.68 | 15.43 |
| Area 7 | 33.88 | 15.43 | 27.23 | 25.57 | 33.88 | 15.43 | 25.57 | 15.43 |

(Left Side Wheels Coated)

### Example 3

### Engines

Engines and all components under the hood of a vehicle, marine, aircraft, equipment, mobile or hydraulic equipment or heavy equipment; engines, engine rooms, or machine spaces on a boat or ship can coated to preserve the effects of heat, increase cleanliness, restore the finishes, and for ease of cleaning. The surfaces are washed to be free of organic contamination. Then, as with the wheels, the siloxane coating is sprayed on all surfaces including exhaust manifolds. Usually a siloxane containing simple organic groups is used so that the organic group leaves the surface at high temperature without toxicity, generally leaving a silicon-oxygen polymer (siloxane) stable at very high temperatures up to 1500 to 2000° F.

### Example 4

### Car Engine

An engine in a 1998 vehicle having approximately 70,000 miles on the odometer was washed with a quality degreasing soap to reveal clean but oxidized surfaces from heat generated under the hood. After spraying on a siloxane coating, the surfaces were restored to a new look. The same vehicle at over 120,000 miles, i.e. over 50,000 miles of use with high heat exposure, showed virtually no contaminant build up or surface oxidation. The appearance of the vehicle's under hood surfaces was easily maintained by either water cleaning with a hose or with a mild detergent if grease or oil had built up from a leak.

In summary, the ability to keep a vehicle, marine, ship, aircraft or mobile equipment clean can reduce maintenance costs from cleaning, when cleaning is necessary for service or repair. Similarly, external vehicle surfaces can be rendered hydrophobic, oleophobic, resistant to decontaminant build up on all surfaces, including but not limited to, metals, paint, plastics, fiberglass, gel coat, chrome, rubber, synthetic compounds and glass.

### Example 5

### Diesel Turbine Exhaust Eductors

Diesel turbine generator exhaust eductors called BLISS caps are installed on some classes of ships. BLISS caps are typically fabricated of corrosion-resistant steel Alloy 316L. Some are painted with a gray epoxy-siloxane paint. This paint typically fails by temperature cycling, high temperatures, and the corrosive marine environment, and also suffers discoloration from soot build up. In a demonstration while the a ship was in an Altantic Coast dry dock, the epoxy-siloxane paint was removed from one BLISS cap by ultra-high pressure water blasting to reveal an abrasively blasted profile of approximately 2 mils from original construction. Two, 3-part quart kits of reactive silanol were catalyzed and inducted for 30 minutes before being applied to BLISS cap surfaces by airless sprayer to a wet film thickness estimated to be approximately 1 mil. Excess reactive silanol that formed droplets on the vanes was removed by disposable foam brush. The film was tack free in one hour. After eight months service, the Chief Engineer for the ship reported that not only was the siloxane film intact, but that the “soot washes off in the rain.”

### Example 6

### Easy-Clean Surface Treatment Over Paint in Way of Diesel Exhaust

Soot from engine exhausts from the freeboard discolors and defaces the paint or gel coat on freeboards. Maintenance-intensive cleaning is required to remove the soot. Cleaning removes gloss and damages the paint or gel coat. In a demonstration performed on two ships representing both coasts of Florida, one freeboard on each test ship coated with a white paint consisting of either epoxy primer with a silicone alkyd topcoat or a white epoxy-siloxane paint in way of the diesel exhaust were cleaned with a mild surfactant cleaner and treated with a catalyzed 3-part reactive silanol applied by roller and natural hair brush while the ship was tied to a pier. After several months of service, soot discoloration and defacement was reported as mitigated and any residual soot was easily removed with mild detergent and, at most, nylon fiber brushes without damage to the gloss of the siloxane film.

### Example 7

### Contaminant-Resistant Exterior Paint Treatment

Two 15,000 bbl fuel storage tanks near Jacksonville, Fla. typically exposed to the elements and air pollutants from nearby aircraft operations were treated with reactive silanol in addition to several test coupons mounted on a south facing test rack. The coupons and tanks were coated with an epoxy barrier paint and a polyurethane topcoat. Two of three tanks and several coupons were coated with a 2-part catalyzed reactive silanol applied by rolling to an estimated wet film thickness of 1 mil, while a third tank and several coupons were uncoated. After two years exposure, the north-facing sides of the coupons exhibited mold or algae spots whereas the coupons treated with reactive silanol were mold and algae free. Soot appeared to wash off the treated tanks in the rain.

### Example 8

### Battery Racks

Steel racks for holding back-up power lead-acid batteries suffer paint discoloration and failure due to spillage from topping off the battery cells with water and from accumulation of dirt. The racks are often painted with a bright color high-visibility coating to help workers avoid bumping into the racks. In one recent demonstration at a commercial facility, battery racks on one side of the aisle were treated with a 3-part catalyzed reactive silanol applied by airless paint sprayer whereas the opposite rack was not treated. After several months of normal maintenance and adding water to the batteries, the treated side exhibited cleaner, brighter paint relatively free of acid damage whereas the untreated side exhibited faded paint with some acid damage.

### Example 9

### Industrial Gas Turbines

Industrial Gas Turbines (IGTs) typically operate in corrosive and polluted environments that reduce mean time to failure or maintenance due to corrosion, abrasive damage, or dirt attacking housings, intakes, and blades. In a demonstration on an IGT installed aboard an offshore platform, 3-part reactive silanol was catalyzed, inducted for 30 minutes, and applied by spray and brush to the housings, exhaust, and condenser section of the turbine. After several months of service, treated surfaces resisted build up of contaminants and corrosion products allowing easier cleaning and increasing operational hours before failure approximately 50%.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A method of forming a thin coating of interpenetrating polysiloxane with organic moieties predominantly oriented toward the exposed surface of said coating to produce a permanent positive surface potential of said coating onto a substrate comprising:
A. a reactive silanol by mixing constituent components sufficiently to hydrolyze component silanes into predominantly linear low molecular weight oligomeric silanol coating composition wherein said coating composition comprises an aqueous or non-aqueous oligomeric low molecular weight silanol coating composition formed by admixing:
i. at least one silane of the formula (1)
R¹ₙSi(OR²)₄₋ₙ (1)
wherein:
R¹ represents a methyl group; a C₁-C₆ alkyl group; a C₆-C₈ aryl group or a functional group including at least one of vinyl, acrylic, amino, mercapto, or vinyl chloride functional groups; or higher nonhydolyzable moiety such as, but not limited to 3,3,3-trifluoropropyl, gamma-glycidyloxypropyl, and gamma-methacryloxypropyl;
R² represents a methyl group; a C₁-C₆ alkyl or acetyl group and n is a number of 1 or 2;
ii. either a water soluble organic acid or a base component;
iii. water in a quantity to hydrolyze said silanes and to promote formation of linear silanols;
B. applying to said substrate said catalyzed coating composition;
C. allowing the water and alkanol to evaporate and the condensate to cure whereby a hard, low porosity interpenetrating network of organosolixanes with organic moieties oriented toward the surface is formed on the substrate.

2. A method of forming onto a substrate a hydrophobic and oleophobic coating which repels contaminants by discouraging light hydrogen bonding thereto, comprising:
A. precatalyzing a reactive silanol by mixing constituent components sufficiently to partially hydrolyze component silanes and inducting for a sufficient time to form linear very low molecular weight oligomeric silanols;
B. suspending the condensation reactions by adding excess solvent wherein said coating composition comprises an aqueous or non-aqueous oligomeric low molecular weight silanol coating composition formed by admixing:
i. at least one silane of the formula (1)
R¹ₙSi(OR²)₄₋ₙ (1)
wherein:
R¹ represents a methyl group, a C₁-C₆ alkyl group, a C₆-C₈ alkyl group or a functional group including at least one of vinyl, acrylic, amino, mercapto, or vinyl chloride functional groups, or higher nonhydolyzable moiety such as, but not limited to 3,3,3 trifluoropropyl, gammaglycidyloxypropyl and gamma-methacryloxypropyl;
R² represents a methyl group, a C₁-C₆ alkyl or acetyl group and n is a number of 1 or 2;
ii. a base component;
iii. water in an amount less than that needed to hydrolyze all silanes;
iv. C₂-C₄ alkanol solvent;
C. applying to said substrate said catalyzed coating composition;
D. allowing the water and alkanol to evaporate and the condensate to cure whereby a hard, low porosity interpenetrating network of organosolixanes with organic moieties oriented toward the surface is formed on the substrate.

3. A method of forming a thin coating of interpenetrating polysiloxane with organic moieties predominantly oriented toward the exposed surface of said coating to produce a permanent positive surface potential of said coating onto a substrate comprising:
A. applying to the substrate an aqueous admixture including:
i. at least one silane of the formula (1)
R¹Si(OR²)₃ (1)
wherein:
R¹ is a C₁-C₆ alkyl group, a phenyl group or a functional group containing at least one vinyl, acrylic, amino, mercapto, or vinyl chloride functional group; and
R² is a C₁-C₆ alkyl group;
ii. a water-soluble organic acid;
iii. an epoxy silane;
iv. a silane compound of formula (4):
X[R¹Si(OR²)₃]₂ (4)
where R¹ and R² are defined above and X represents an amino group or keto group: 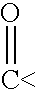
v. water;
B. allowing volatile components of said admixture to evaporate and the remaining condensate to cure forming a hard, substantially non-porous thin protective coating on the substrate.

4. A method of forming onto a substrate a hydrophobic and oleophobic coating which repels contaminants by discouraging light hydrogen bonding thereto, comprising:
A. applying to the substrate an aqueous coating comprising:
at least one silane of the formula (1)
R¹Si(OR²)₃ (1)
wherein:
R¹ is a C₁-C₆ alkyl group, a phenyl group or a bifunctional silane containing vinyl, acrylic, amino or vinyl chloride functional group; and
R² is a C₁-C₆ alkyl group;
water;
C₂-C₄ alkanol; and
chromium acetate hydrozide;
B. allowing the water and alkanol to evaporate and the condensate to cure whereby a hard, low porosity interpenetrating network of organosolixanes with organic moieties oriented toward the surface is formed on the substrate.

5. A method of forming a thin coating of interpenetrating polysiloxane with organic moieties predominantly oriented toward the exposed surface of said coating to produce a permanent positive surface potential of said coating onto a substrate comprising:
A. at least one silane of the formula (1)
R¹Si(OR²)₃ (1)
wherein:
R¹ is a C₁-C₆ alkyl group, a phenyl group or a functional group containing at least one vinyl, acrylic, amino, mercapto, or vinyl chloride functional group; and
R² is a C₁-C₆ alkyl group;
a base component;
water; and
a gellation-inhibiting amount of silane hydrolysis catalyst comprising chromium acetate hydroxide.
B. allowing the volatile components of said coating to evaporate and remaining condensed components to cure forming a hard, glossy, thin, substantially non-porous protective coating on the substrate.

6. A dense contaminant repellent siloxane coating composition formed onto a substrate wherein organic moieties of said coating are oriented toward the exposed surface thereof causing a permanent positively charged surface potential comprising:
a reactive silanol catalyzed by mixing constituent components sufficiently to hydrolyze component silanes into predominantly linear low molecular weight oligomeric silanol coating composition wherein said coating composition comprises an aqueous or non-aqueous oligomeric low molecular weight silanol coating composition formed by admixing:
i. at least one silane of the formula (1)
R¹ₙSi(OR²)₄₋ₙ (1)
wherein:
R¹ represents a methyl group; a C₁-C₆ alkyl group; a C₆-C₈ aryl group or a functional group including at least one of vinyl, acrylic, amino, mercapto, or vinyl chloride functional groups; or higher nonhydolyzable moiety such as, but not limited to 3,3,3-trifluoropropyl, gamma-glycidyloxypropyl, and gamma-methacryloxypropyl;
R² represents a methyl group; a C₁-C₆ alkyl or acetyl group and n is a number of 1 or 2;
ii. either a water soluble organic acid or a base component;
iii. water in a quantity to hydrolyze said silanes and to promote formation of linear silanols;
whereby, when water and alkanol evaporate and condensate produced thereby is cured, a hard, low porosity interpenetrating network of organosolixanes with organic moieties oriented toward the surface is formed on the substrate.

7. A hydrophobic and oleophobic coating composition formed onto a substrate which repels contaminants by discouraging light hydrogen bonding thereto, comprising:
a precatalyzed reactive silanol formed of mixed constituent components sufficiently to partially hydrolyze said constituent components to form linear very low molecular weight oligomeric silanols;
at least one silane of the formula (1)
R¹ₙSi(OR²)₄₋ₙ (1)
wherein:
R¹ represents a methyl group, a C₁-C₆ alkyl group, a C₆-C₈ alkyl group or a functional group including at least one of vinyl, acrylic, amino, mercapto, or vinyl chloride functional groups, or higher nonhydolyzable moiety such as, but not limited to 3,3,3 trifluoropropyl, gammaglycidyloxypropyl and gamma-methacryloxypropyl;
R² represents a methyl group, a C₁-C₆ alkyl or acetyl group and n is a number of 1 or 2;
a base component;
water in an amount less than that needed to hydrolyze all silanes;
C₂-C₄ alkanol solvent;
whereby, when water and alkanol evaporate and the remainder of said constituent components condensate and cure, a hard, low porosity interpenetrating network of organosolixanes with organic moieties oriented toward the surface is formed on the substrate.

8. A dense contaminant repellent siloxane coating composition formed onto a substrate wherein organic moieties of said coating are oriented toward the exposed surface thereof causing a permanent positively charged surface potential comprising:
an aqueous admixture including:
at least one silane of the formula (1)
R¹Si(OR²)₃ (1)
wherein:
R¹ is a C₁-C₆ alkyl group, a phenyl group or a functional group containing at least one vinyl, acrylic, amino, mercapto, or vinyl chloride functional group; and
R² is a C₁-C₆ alkyl group;
a water-soluble organic acid;
an epoxy silane;
a silane compound of formula (4):
X[R¹Si(OR²)₃]₂ (4)
where R¹ and R² are defined above and X represents an amino group or keto group: 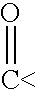
water;
whereby, when volatile components of said admixture evaporate, a remaining condensate cures to form a hard, substantially non-porous thin protective coating on the substrate.

9. A hydrophobic and oleophobic coating composition formed onto a substrate which repels contaminants by discouraging light hydrogen bonding thereto, comprising:
an aqueous admixture comprising:
at least one silane of the formula (1)
R¹Si(OR²)₃ (1)
wherein:
R¹ is a C₁-C₆ alkyl group, a phenyl group or a bifunctional silane containing vinyl, acrylic, amino or vinyl chloride functional group; and
R² is a C₁-C₆ alkyl group;
water;
C₂-C₄ alkanol; and
chromium acetate hydroxide;
whereby, when the water and alkanol evaporate and remaining components of said admixture condensate and cure, a hard, low porosity interpenetrating network of organosolixanes with organic moieties oriented toward the surface is formed on the substrate.

10. A dense contaminant repellent siloxane coating composition formed onto a substrate wherein organic moieties of said coating are oriented toward the exposed surface thereof causing a permanent positively charged surface potential comprising:
at least one silane of the formula (1)
R¹Si(OR²)₃ (1)
wherein:
R¹ is a C₁-C₆ alkyl group, a phenyl group or a functional group containing at least one vinyl, acrylic, amino, mercapto, or vinyl chloride functional group; and
R² is a C₁-C₆ alkyl group;
a base component;
water; and
a gellation-inhibiting amount of silane hydrolysis catalyst comprising chromium acetate hydroxide.
whereby, when the volatile components of said coating composition evaporate and remaining condensed components thereof cure, a hard, glossy, thin, substantially non-porous protective coating on the substrate.

11. A method as set forth in claim 2, further comprising:
E. applying a hardener by mechanical polishing to form and cure said siloxane at ambient temperatures whereby a hard, low porosity interpenetrating network of organosolixanes with organic moieties oriented toward the surface is formed on the substrate.

12. A coating composition as set forth in claim 7, further comprising:
a hardener applied by mechanical polishing to form and cure said siloxane at ambient temperatures whereby a hard, low porosity interpenetrating network of organosolixanes with organic moieties oriented toward the surface is formed on the substrate.
